(19) United States
(12) Patent Application Publication
(10) Pub. No.: US 2015/0326750 A1
(43) Pub. Date: Nov. 12, 2015

(54) DATA HIDING METHOD VIA REVISION RECORDS ON A COLLABORATION PLATFORM

(71) Applicant: National Chiao Tung University, Hsinchu City (TW)

(72) Inventors: Ya-Lin LEE, Changhua City (TW); Wen-Hsiang TSAI, Hsinchu City (TW)

(21) Appl. No.: 14/522,033

(22) Filed: Oct. 23, 2014

(30) Foreign Application Priority Data
May 9, 2014 (TW) 103116542

(51) Int. Cl. H04N 1/32; G06F 17/24

(52) U.S. Cl. CPC H04N 1/32149; G06F 17/24; H04N 1/32352

(57) ABSTRACT

The present invention provides a data hiding method via revision records on a collaboration platform, which first creates a collaborative database including a plurality of articles and revision records. A user puts as input a cover document, a secret message, and a key on a collaboration platform. Based on four characteristics of multi-user collaborative-writing processing, the collaborative-writing platform is used, together with a key, to hide a secret message into the cover document automatically while simulating a collaborative-writing process and generate a stego-document where the secret message is hidden. Only authorized users with the key can extract the right secret message from the stego-document i.e. the message-hidden document successfully.

This application claims priority for Taiwan patent application no. 103116542 filed at May 9, 2014, the content of which is incorporated by reference in its entirely.

### BACKGROUND OF THE INVENTION

1. Field of the Invention

The present invention relates to a data hiding method, and more particularly to a data hiding method via revision records on a collaboration platform.

2. Description of the Prior Art

As the cloud systems developed, a variety of collaboration platforms are provided which allow more than one author to collaborate in editing one document, and revision records of the editing process can be stored. Since all of the files and revision records of the document will be uploaded to the Clouds, to protect these files from being attacked and to ensure their safety become a main concern. As a result, professionals in the field are pursuing to search on a new data hiding method to be developed, especially for collaboration platforms used.

In general, a data hiding method is to embed a secret message into a cover media so as to provide a resulting stego-document as a normal output that attackers or hackers cannot realize. Therefore, the data hiding methodology is the art being able applied to various fields comprising convert communications, secret data keeping, access control, database protection, and so on. Conventional types of cover media usually include image, video and audio, etc., because they are more difficult for human-eyes to realize. On the contrary, data hiding techniques using text-type cover media are much less proposed.

For example, only three major data hiding techniques using text-type cover media are commonly used in the prior art, which are (1) format-based method, (2) random and statistical method, and (3) linguistic method. Format-based methods use the physical formats of documents to hide messages, for example, the inter-word spaces without affecting the contents. Random and statistical methods generate directly camouflage texts with hidden messages to prevent the attack of comparison with a known plaintext. Alternatively, duplication patterns such as inputting more spaces, using abbreviation instead, or changing priority of parameters in the program may also be applied to conceal the secret message.

Linguistic methods use written natural languages to conceal secret messages. For instance, a synonym replacement method that generates a cover text according to a secret message using sentence models and synonym dictionary was proposed. Another synonym replacement method that hides data in a text by substituting the words which have different terms in the UK and the US was also proposed as one of the conventional linguistic methods. Alternatively, modifying an original document to a stego-document based on its data-hiding function and revision database, and then tracking the changes of the document so as to get back the original document was also known as another methodology of the conventional linguistic methods used in the prior arts.

Generally speaking, compared to (1) format-based method and (2) random and statistical method, the linguistic methods are believed to show more resistance when being attacked. Recently, more and more collaborative writing platforms, such as Google Drive, Office Web Apps, Wikipedia, and so on are available. On these platforms, a plurality of authors to collaborate in editing one document is allowed, and a large number of revisions generated during the collaborative writing process are recorded. Furthermore, many people working collaboratively on these platforms make it quite necessary for data hiding applications, such as covert communication or secret data keeping, etc. However, the aforementioned methods can only be applied to documents with single author and single revision version, meaning that these conventional methods are not perfect for hiding data on collaborative writing platforms nowadays.

Therefore, on account of above, it should be obvious that there is indeed an urgent need for people having ordinary skills in the art to develop a new data hiding method that can effectively solve those above mentioned problems occurring in the prior design and ensure their safety while collaboration writing process.

### SUMMARY OF THE INVENTION

In order to overcome the above-mentioned disadvantages, one major objective in accordance with the present invention is provided for a data hiding method via revision records on a collaboration platform. The proposed method is aimed to generate a plurality of revisions of an article or document through simulating the article or document with a multi-user collaborative writing process. Then, for every two consecutive revisions, all correction pairs are found are recorded into a collaborative database. As such, the collaborative database is well constructed.

For achieving the above mentioned objectives, the proposed data hiding method via revision records on the collaboration platform utilizes four characteristics of revisions, which comprises: (1) the author of every revision, (2) the number of changed word sequences in every revision, (3) the at least one changed word sequence in every revision, and (4) the new word sequences selected from the collaborative database to replace the changed word sequence, i.e. the replacing word sequences so as to “hide” the secret message into the revisions sequentially.

Moreover, when embedding the secret message into the revisions, a key is involved. By employing such key, only authorized authors with the right key can extract the correct secret message from the revision where it is embedded.

Therefore, the data hiding method via revision records on the collaboration platform of the present invention comprises the following steps: (1) constructing a collaborative database which comprises a plurality of articles and revision records; (2) inputting a cover document, a secret message and a key on the collaboration platform; (3) automatically and artificially transforming the cover document into a stego-document, where the secret message is embedded; and (4) extracting the secret message from the stego-document by at least one authorized user with the key.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention in the drawings:

FIG. 1 shows a basic idea of proposed method that generates a revision history of a stego-document as a camouflage for data hiding in accordance with one embodiment of the present invention.

FIG. 2 shows a flow chart of the data hiding method proposed in accordance with one embodiment of the present invention.

FIG. 3 shows a detailed flow chart of the step S12 in FIG. 2.

FIG. 4 shows an illustrative diagram of construction order of collaborative writing database and revision generation order.

FIG. 5 shows an illustration of encoding authors of revisions for data hiding in accordance with one embodiment of the present invention.

FIGS. 6A-6G show an example of generated stego-document with input secret message “Art is long, life is short” according to one embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts. The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

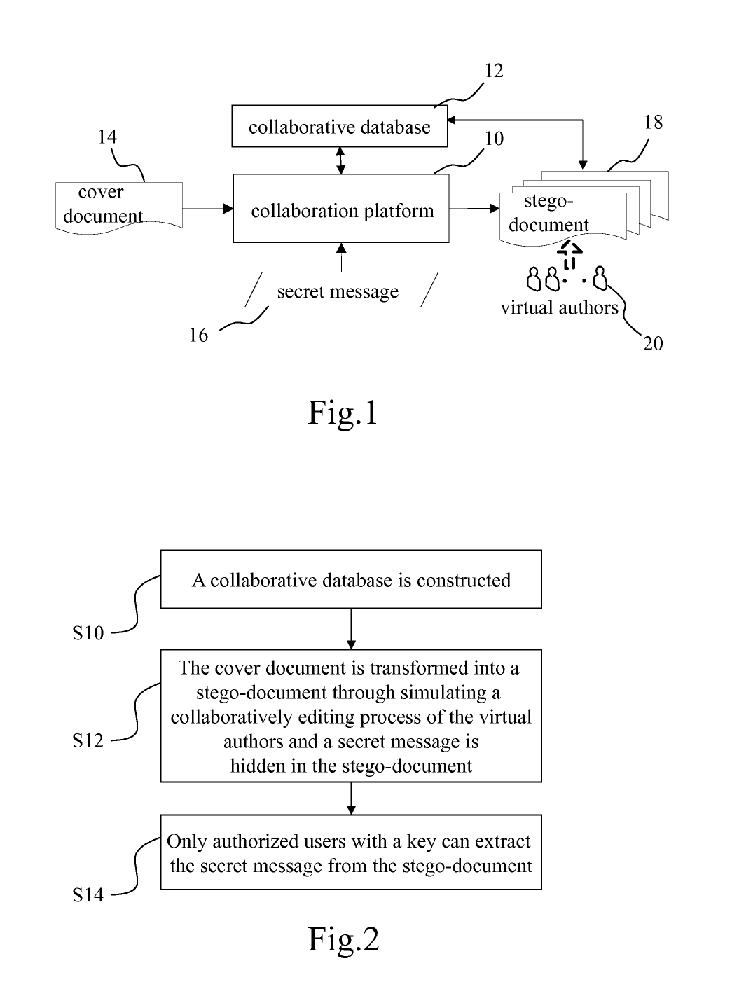

The present invention discloses a data hiding method via revision records on a collaboration platform. The basic idea of proposed method is shown as FIG. 1. As input of a plurality of articles or documents, a user selects one of them as a cover document 14 to hide a secret message 16 into it. A collaboration platform 10 is used to simulate a multi-user collaborative-writing process, which utilizes multiple virtual authors 20 to collaboratively revise the cover document 14 into various different versions and conceal the secret message 16 into the collaborative-writing process. Therefore, a stego-document 18 which includes revision records and seems like being collaboratively edited by the plurality of virtual authors 20 is generated. The revision records and articles are stored in a collaborative database 12.

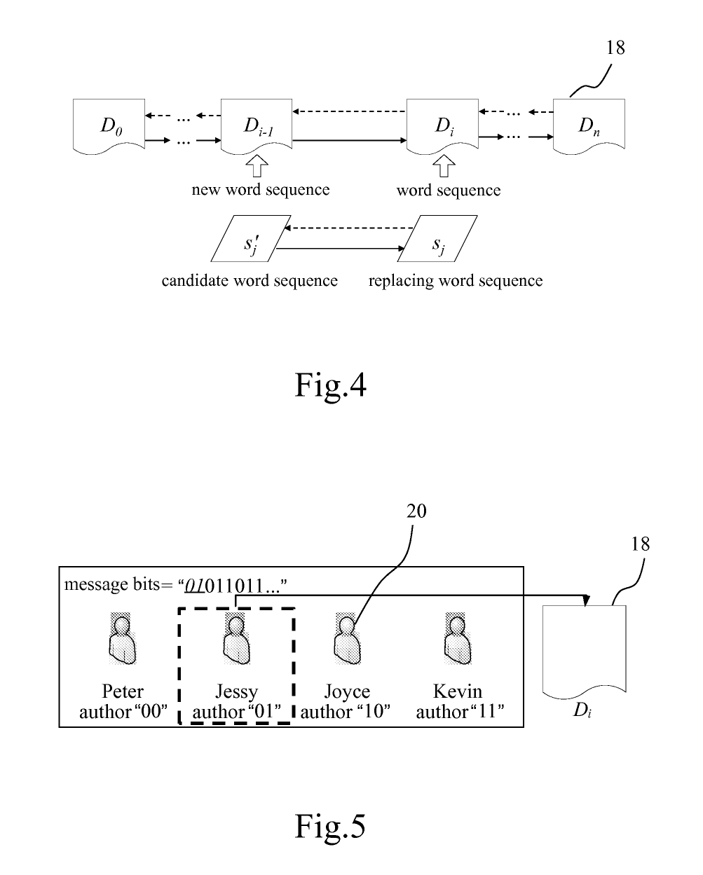

FIG. 2 shows a flow chart of the data hiding method proposed according to one embodiment of the present invention. As shown in the step of S10, a collaborative database is constructed, which comprises articles and revision records. For articles, they can be collected from Wikipedia since there were about 4.2 million articles in the English Wikipedia, which is a very large knowledge repository and suitable as a source for constructing the database. Revision records comprise word sequence corrections which occur between every 2 consecutive revision version of the article. FIG. 4 shows an illustration of used terms and notations according to one embodiment of the present invention.

As illustrated in FIG. 4, an article downloaded from Wikipedia has a set of revisions {D₀, D₁, . . . , Dₙ} in its revision history, where a newer revision Dᵢ has a smaller index i with D₀ being the latest version of the article. In this FIG. 4, the solid lines represents revision generation order, and the dash line represents construction order of collaborative writing database. For every two consecutive revisions Dᵢ and Dᵢ₋₁, all the correction pairs between Dᵢ and Dᵢ₋₁ are found, each denoted as <sⱼ, sⱼ′>, where sⱼ is a word sequence in revision Dᵢ and was corrected to become another, namely, sⱼ₋₁, by the author of revision Dᵢ₋₁. Then, all correction pairs will be found and recorded so as to construct the collaborative database. For example, assume Dᵢ=“National Chia Tang University” and Dᵢ₋₁=“National Chiao Tung University.” Then, the correction pair <s₁, s₁′>=<“Chia Tang”, “Chiao Tung”> is generated and included into the collaborative database. Furtherover, according to another embodiment of the present invention, a novel algorithm can also be used for finding automatically all of the correction pairs between every two consecutive revisions for inclusion in the collaborative database. The algorithm is an extension of the longest common subsequence (LCS) algorithm.

Next, as shown in the step of S12, a secret message is embedded. The user inputs a cover document, the secret message to be embedded and a key on the collaboration platform, and the collaboration platform automatically and artificially makes the cover document become a stego-document which comprises the collaboratively editing process of the virtual authors and the secret message hidden in the document.

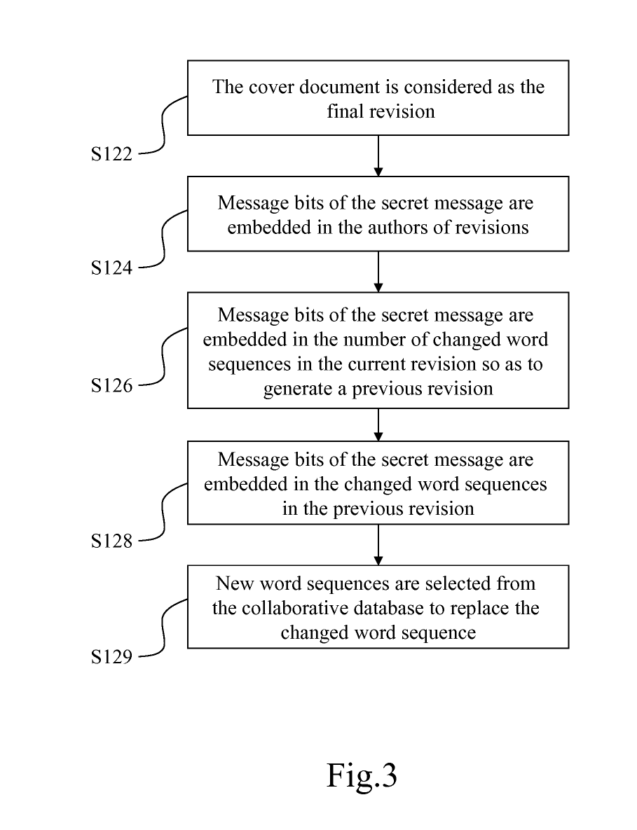

For the details of step S12, please refer to FIG. 3. As the step of S122, in the phase of message embedding with a cover document as the input, the proposed method is designed to provide the cover document as the final revision Dₙ, and provide consecutive revisions {Dₙ₋₁, Dₙ₋₂, . . . , D₁, D₀} by producing a previous revision a from the current revision Dₙ₋₁ repeatedly until the entire message is embedded as shown in FIG. 4, where the direction of revision generation order is indicated by the solid lines and the direction of construction order of collaborative writing database is indicated by dash lines. The stego-document Dₙ including the revision history {Dₙ₋₁, Dₙ₋₂, . . . , D₁, D₀} then is kept on the collaborative writing platform, which may be Wikipedia or others. To simulate a collaborative writing process more realistically, the present invention utilizes four characteristics of revisions to “hide” the message bits into the revisions sequentially: (1) the author of every revision, (2) the number of changed word sequences in every revision, (3) the at least one changed word sequence in every revision, and (4) the new word sequences selected from the collaborative database to replace the changed word sequence, i.e. the replacing word sequences, as shown in steps of S124˜S129, respectively. As shown in S124, the authors of revisions are encoded to hide message bits in the proposed method. For this, at first a group of simulated authors are selected, with each author being assigned a unique code a, called author a. Then, if the message bits to be embedded form a code aⱼ, then the author aⱼ will be assigned to the revision Dᵢ as its author to achieve embedding of message bits aⱼ into Dᵢ. For example, assume that four authors are selected and each is assigned a unique code a, as shown in FIG. 5, respectively. If the message bits aⱼ to be embedded is “01,” then Jessy with author code “01” is selected to be the author of the revision Dᵢ. Moreover, every revision of D₀ through Dₙ will be assigned an author according to the corresponding message bits, and so an author can be assigned to conduct more than one revision or reversely no revision in the generated revisions, which in turns fits the real situation of multi-user collaborating process.

Next, the step of S126 uses the number of changed word sequences for data hiding and generates the previous revision Dᵢ from the current one Dᵢ₋₁. In this process, some word sequences in Dᵢ₋₁ are selected and changed into other ones in Dᵢ. It is desired to use as well the number of word sequences changed in this process N_{g} as a message-bit carrier. To implement this aim, at first the present invention sets on the magnitude of N_{g} a limit N_{c} taken to be the maximum allowed number of word sequences in Dᵢ₋₁ that can be changed to yield Dᵢ. This limitation makes the simulated step of revising Dᵢ₋₁ to become Dᵢ look more realistic because usually not very many words are corrected in a single revision. Next, the proposed method scans the word sequences in the text of the current revision Dᵢ₋₁ sequentially and search the database to find all the correction pairs <sⱼ, sⱼ′> with sⱼ′ in Dᵢ₋₁. Then, collect all sⱼ′ in these pairs as a set Qᵣ, which is called as the candidate set of word sequences for changes in Dᵢ₋₁. Finally, N_{g} word sequences will be selected out of Qᵣ to form a set such that the binary version of the number N_{g} is just the current message bits to be embedded. In one embodiment, if the number of candidate word sequences for changes is 3 and the binary version of the number 3 is 11, then the secret message bits to be embedded will be “11”.

In the step of S128, the secret message bits will be embedded in the changed word sequence in the previous revision Dᵢ, and the candidate set of word sequences for changes in Qᵣ will be divided into N_{g} groups. In each group, at least one changed word sequence sⱼ′ will be selected as for secret message to be embedded in.

As for step S129, certain new word sequences, i.e. the replacing word sequences are selected from the collaborative database to replace the changed word sequence sⱼ′ in S128. A number N_{g} of changed word sequence sⱼ′ are selected from the previous revision Dᵢ which are the new word sequence in S126. Since the new word sequences are re-selected in the step of S128 to form a set, the candidate set of word sequences for changes will accordingly be the same as the new word sequences. Among the number N_{g} of changed word sequence sⱼ′ being selected and the revision times each sⱼ′ replacing sⱼ, a Huffman coding technique based on the collaborative writing database is adopted to provide specific codes for every new word sequence which will be selected. As such, every new word sequence will be characterized with a relative code, and the replacing sⱼ can be decided based on the secret message. After using the changed word sequence sⱼ′ to replace sⱼ, the current version of revision Dᵢ₋₁ is successfully formed.

At last, as shown in the step of S14 in FIG. 2, only authorized users with the right key can extract the correct secret message from the stego-document, since only they have the access to obtain the information of correction pairs, relative codes for each new word sequence, and so on.

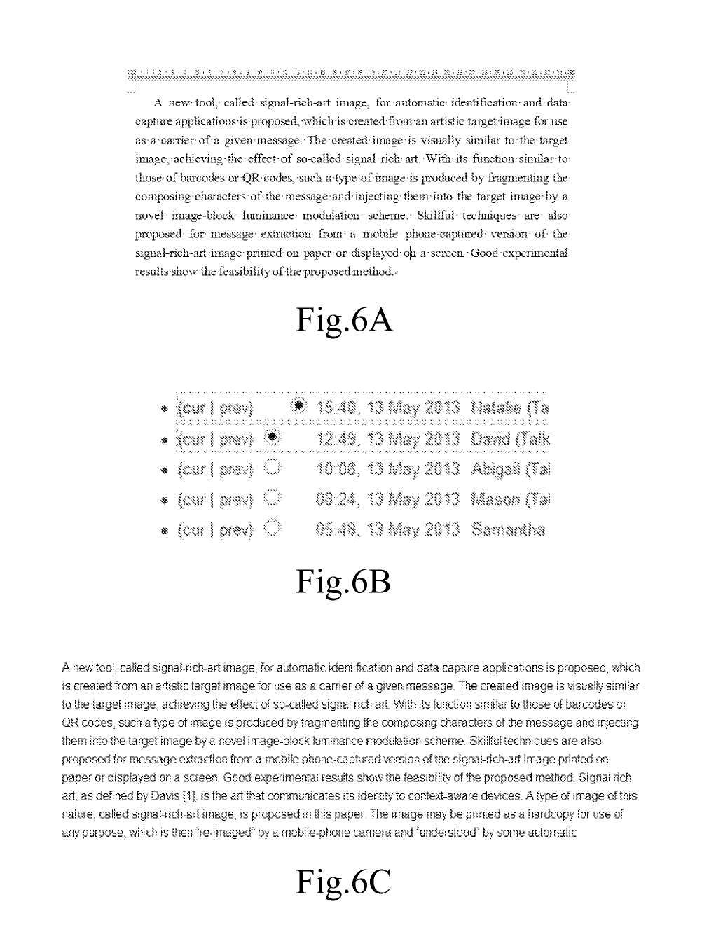

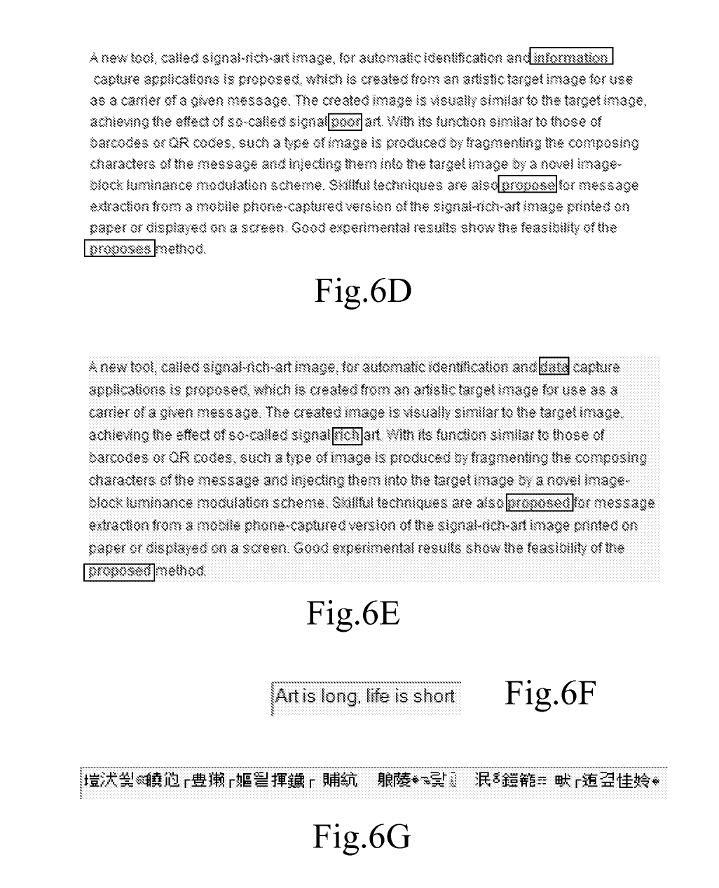

FIGS. 6A-6G show an example of generated stego-document according to one embodiment of the present invention. In FIG. 6A, an article is selected as cover document where the secret message “Art is long, life is short” will be embedded. After simulating the multi-user collaboratively writing process on the platform is performed, five different revision records are shown as FIG. 6B, which includes the revision date, time, and author name and “Natalie” is the author of the latest version of revision. FIG. 6C shows the stego-document which have exactly the same contents as the cover document shown in FIG. 6A. FIG. 6E is the latest version of revision with contents same as the cover document in FIG. 6A. FIG. 6D is the previous version of FIG. 6E, with words as indicated being corrected to be new ones in FIG. 6E. The revision records are inclusive of the secret message. As shown in FIG. 6F, a user with a right key can extract the correct secret message from the version of FIG. 6E, while compared to FIG. 6G, which shows a wrong extracted secret message with a wrong key, the wrong extracted message becomes a bunch of gibberish. Therefore, it is believed that the data hiding method proposed in the present invention is beneficial and effective to secure safety for secret messages to be embedded in any type of documents.

To sum up, the present invention provides a novel data hiding method via revision records on a collaboration platform. The proposed method first analyzes an existing writing platform on the internet, and obtain useful information from the at least one existing platform so as to construct a collaborative database. An article is then selected from the database as a cover document for the secret message to be embedded in. As such, a stego-document which seems exactly the same as the original cover document but in fact comprising the secret message and revision records of virtual authors is created. The revision records are together with the document to be stored in the database. To embed the secret message and simulate a collaborative writing process, the proposed method utilizes four characteristics of revisions to “hide” the message bits into the revisions sequentially. Moreover, based on the number of times the word sequence in the article is revised, a Huffman coding technique is further adopted to encode this value, i.e. the number of times of the revisions such that the whole simulating process seems more realistically. By employing the proposed method of the present invention, it can be effectively applied to documents with more than one author and revision versions, meaning that the proposed method of the present invention is not only perfect for hiding data on collaborative writing platforms but also useful for convert communications, secret data keeping, access control, database protection, and so on.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A data hiding method via revision records on a collaboration platform, comprising steps of:
constructing a collaborative database which comprises a plurality of articles and revision records;
inputting a cover document, a secret message and a key on said collaboration platform, in which said cover document is automatically and artificially transformed into a stego-document, comprising a collaboratively editing process of virtual authors and said secret message is hidden in said stego-document, and
extracting said secret message from said stego-document by at least one authorized user with said key.

2. The data hiding method of claim 1, wherein said secret message is hidden in said stego-document, and a plurality of characteristics of said collaboratively editing process are utilized, comprising: author of every revision, a number of changed word sequence in every revision, at least one changed word sequence in every revision, and at least one new word sequence selected from said collaborative database to replace said changed word sequence.

3. The data hiding method of claim 1, further comprising using an extension of the longest common subsequence (LCS) algorithm to compare every two consecutive revisions of said articles so as to find all correction pairs and to obtain said revision records; and storing said revision records in said collaborative database.

4. The data hiding method of claim 2, in said step of creating said stego-document further comprising:
considering said cover document as a final revision of said article; and
providing consecutive revisions according to said characteristics of said collaboratively editing process by producing a previous revision from a current revision repeatedly until said entire secret message is embedded so as to create said stego-document.

5. The data hiding method of claim 4, wherein when said secret message is hidden in said stego-document according to said author of every revision, said virtual authors on said collaboration platform are selected with each being assigned a unique code, and message bits of said secret message are the same as said unique code of said at least one virtual author, said at least one virtual author will be selected as author of said current revision so that said message bits of said secret message are successfully embedded into said at least one virtual author.

6. The data hiding method of claim 4, wherein when said secret message is hidden in said stego-document according to said number of changed word sequence in every revision, a limit taken to be maximum allowed number of word sequences that can be changed is set; word sequences in text of said current revision is scanned sequentially with searching said database such that all correction pairs can be found; said new word sequence is compared to said changed word sequence in said previous revision and collected to become a set; out of said set a plurality of candidate word sequences for changes is chosen; and a binary version of said candidate word sequences for changes is calculated such that message bits of said secret message can be embedded into said binary version of said candidate word sequences for changes.

7. The data hiding method of claim 6, wherein when said secret message is hidden in said stego-document according to said changed word sequence in every revision, said candidate word sequences for changes will be divided into a plurality of groups; and at least one of said candidate word sequences for changes in each group will be selected as for said secret message to be embedded in.

8. The data hiding method of claim 7, in said step of selecting said new word sequence from said collaborative database to replace said changed word sequence further comprising: choosing a plurality of new word sequences from said previous revision and assigning specific code to every new word sequence; deciding at least one changed word sequence based on said secret message; and replacing said changed word sequence with said new word sequence to form said current revision.

9. The data hiding method of claim 8, wherein said specific code is analyzed through a number of times of revisions, and a Huffman coding technique is adopted to provide said specific code to every new word sequence based on said number of times of revisions.
